(19) United States
(12) Patent Application Publication
(10) Pub. No.: US 2025/0324096 A1
(43) Pub. Date: Oct. 16, 2025

(54) SCALING-ONLY AFFINE MODE

(71) Applicant: GOOGLE LLC, Mountain View, CA (US)

(72) Inventors: Xiang Li, Saratoga, CA (US); Debargha Mukherjee, Cupertino, CA (US); Yaowu Xu, Saratoga, CA (US); Jingning Han, Santa Clara, CA (US)

(21) Appl. No.: 19/096,947

(22) Filed: Apr. 1, 2025

Related U.S. Application Data
(60) Provisional application No. 63/632,621, filed on Apr. 11, 2024.

(51) Int. Cl. H04N 19/70; H04N 19/103; H04N 19/139; H04N 19/157; H04N 19/176; H04N 19/50

(52) U.S. Cl. CPC H04N 19/70; H04N 19/103; H04N 19/139; H04N 19/157; H04N 19/176; H04N 19/50

(57) ABSTRACT

Decoding a current block includes decoding, from a compressed bitstream, at least one syntax element indicating that an affine model used for decoding the current block is a scaling-only affine model. The at least one syntax element is not a parameter of the affine model. A prediction for the current block is to be obtained using the affine model. Parameters of the scaling-only affine model are decoded from the compressed bitstream. A prediction block is then obtained for the current block using the scaling-only affine model.

### CROSS REFERENCE TO RELATED APPLICATIONS

This application claims priority to and the benefit of U.S. Provisional Patent Application Ser. No. 63/632,621, filed Apr. 11, 2024, the entire disclosure of which is incorporated herein by reference.

### BACKGROUND

Digital video streams may represent video using a sequence of frames or still images. Digital video can be used for various applications including, for example, video conferencing, high-definition video entertainment, video advertisements, or sharing of user-generated videos. A digital video stream can contain a large amount of data and consume a significant amount of computing or communication resources of a computing device for processing, transmission, or storage of the video data. Various approaches have been proposed to reduce the amount of data in video streams, including compression and other coding techniques. These techniques may include both lossy and lossless coding techniques.

### SUMMARY

This disclosure relates generally to encoding and decoding video data and more particularly relates to a scaling-only affine mode.

An aspect of the disclosed implementations is a method for coding a current block. The method includes decoding, from a compressed bitstream, at least one syntax element indicating that an affine model used for decoding the current block is a scaling-only affine model, where the at least one syntax element is not a parameter of the affine model, and where a prediction for the current block is to be obtained using the affine model. The method also includes decoding, from the compressed bitstream, parameters of the scaling-only affine model. The method also includes obtaining a prediction block for the current block using the scaling-only affine model.

An aspect of the disclosed implementations is a device that includes a memory and a processor. The processor is configured to execute instructions stored in the memory to decode, from a compressed bitstream, at least one syntax element indicating that an affine model used for decoding a current block is a scaling-only affine model, where the at least one syntax element is not a parameter of the affine model, and where a prediction for the current block is to be obtained using the affine model. The device also includes decode, from the compressed bitstream, parameters of the scaling-only affine model; and obtain a prediction block for the current block using the scaling-only affine model.

An aspect of the disclosed implementations is a non-transitory computer-readable storage medium that stores executable instructions that, when executed by a processor, facilitate performance of operations for coding a current block. The operations include decoding, from a compressed bitstream, at least one syntax element indicating that an affine model used for decoding the current block is a scaling-only affine model, where the at least one syntax element is not a parameter of the affine model, and where a prediction for the current block is to be obtained using the affine model. The method also includes decoding, from the compressed bitstream, parameters of the scaling-only affine model. The method also includes obtaining a prediction block for the current block using the scaling-only affine model.

It will be appreciated that aspects can be implemented in any convenient form. For example, aspects may be implemented by appropriate computer programs which may be carried on appropriate carrier media which may be tangible carrier media (e.g. disks) or intangible carrier media (e.g. communications signals). Aspects may also be implemented using suitable apparatus which may take the form of programmable computers running computer programs arranged to implement the methods and/or techniques disclosed herein. For example, a non-transitory computer-readable storage medium may include executable instructions that, when executed by a processor, facilitate performance of operations operable to cause the processor to carry out any of the methods described herein. Aspects can be combined such that features described in the context of one aspect may be implemented in another aspect.

These and other aspects of the present disclosure are disclosed in the following detailed description of the embodiments, the appended claims, and the accompanying figures.

### BRIEF DESCRIPTION OF THE DRAWINGS

The description herein refers to the accompanying drawings described below wherein like reference numerals refer to like parts throughout the several views.

FIG. 1 is a schematic of a video encoding and decoding system.

FIG. 2 is a block diagram of an example of a computing device that can implement a transmitting station or a receiving station.

FIG. 3 is a diagram of an example of a video stream to be encoded and subsequently decoded.

FIG. 4 is a block diagram of an encoder.

FIG. 5 is a block diagram of a decoder.

FIG. 6 illustrates an example of subblock-based motion derivation using an affine model.

FIG. 7 illustrates an example of prediction refinement with optical flow (PROF).

FIG. 8 illustrates another example of affine motion compensation.

FIG. 9 is a flowchart diagram of a method or technique for decoding a current block using an affine model.

FIG. 10 illustrates an example of a portion of a compressed bitstream usable with the scaling-only affine mode.

### DETAILED DESCRIPTION

Video compression schemes may include breaking respective images, or frames, into smaller portions, such as blocks, and generating an output bitstream using techniques to limit the information included for respective blocks in the output. An encoded bitstream can be decoded to re-create the source images from the limited information.

Typical video compression and decompression schemes use motion compensation that assumes purely translational motion between or within blocks to predict the motion within blocks of frames to be encoded or decoded. A motion vector (MV) can be used to find (e.g., identify, locate, select, etc.) a prediction of a coding block in a reference frame. The position of the current block (e.g., the position (x₀, y₀) of a top-left pixel or the position (x_{c}, y_{c}) of a center pixel), may be first mapped in the reference frame. The position in the reference frame can then be displaced by the MV to identify a target reference block. The MV can have sub-pixel precision (e.g., ⅛ pixel precision). That is, in the translational model, the best matching block for a current block is found by identifying (e.g., matching) a reference block in the reference frame and having the same two-dimensional orientation and size as the current block.

The translational model of motion prediction works well when the motion in the video is relatively simple. However, not all motion across images (and hence between video frames) may be translational. As a result, a translational motion mode is not capable of precisely describing more complicated motion, such as rotation, zooming, shear, etc. To overcome this deficiency, various affine motion models have been developed to implement a warped motion mode. Affine transformation is a linear transform between the coordinates of two spaces that is determined by six affine coefficients. While the affine transformation may include translational motion, it can also encompass scaling, rotation and shearing. Therefore, an affine motion model is able to capture more complex motion than the conventional translational model. The affine transformation model can project a pixel at (x, y) of the current block to a prediction pixel at (x′, y′) in a reference frame through formula (1).

$$[ \begin{matrix}{x}^{′} \\ {y}^{′}\end{matrix} ] = [ \begin{matrix}a & b & c \\ d & e & f\end{matrix} ] [ \begin{matrix}x \\ y \\ 1\end{matrix} ] \qquad ( 1 )$$

In formula (1), the tuple (c, f) corresponds to a conventional MV that can be used in a translational model; the parameters a and e can be used to control the scaling factors in the vertical and horizontal axes, and in conjunction with the parameters b and d decide (e.g., determine, set, etc.) a rotation angle. While affine transformation models are used as an illustrative examples herein, the warping model can generally be a homographic model.

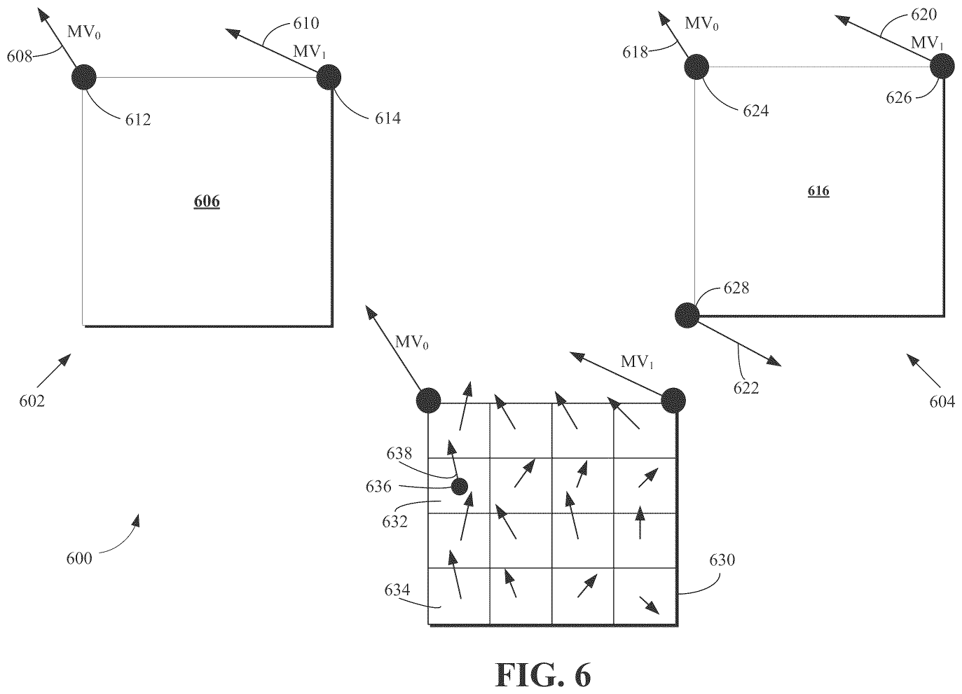

Different codecs have implemented different affine models that use four or six parameters. Examples of such implementations are described with respect to FIGS. 6-8. At a high level, an encoder may signal (i.e., encode in a compressed bitstream) and a decoder may decode from the compressed bitstream four or six parameters for affine transformations. Decoding the four or six parameters includes decoding values (such as motion vectors of control points) that can be used to derive (e.g., calculate) the parameters of the affine mode.

When a scaling-only transformation is desired, the encoder still encodes zero (0) values for those parameters unrelated to scaling therewith increasing the size of the bitstream and reducing compression efficiency. In addition to the increased bitstream size, other problems (e.g., high computation complexity, reduced prediction accuracy, etc.) may be associated with the different implementations, as further described with respect to FIGS. 6-8.

Scaling-only transformation is particularly desired in common video scenarios such as camera zoom operations (both optical and digital zoom), dolly shots where the camera moves directly toward or away from a subject, perspective changes due to subject movement toward or away from a fixed camera, content playback with picture-in-picture effects, and video conferencing applications where participants frequently adjust their distance from the camera. These scenarios represent a significant portion of motion patterns in typical video content, making efficient encoding of scaling transformations particularly valuable for overall compression performance.

Implementations according to this disclosure solve problems such as the foregoing via a scaling-only affine mode (e.g., transformation), which reduces the signaling cost. An encoder may signal to the decoder that the decoder is to perform a scaling-only transformation. Accordingly, the decoder need not decode, and the bitstream would not include, parameters related to rotation and shearing.

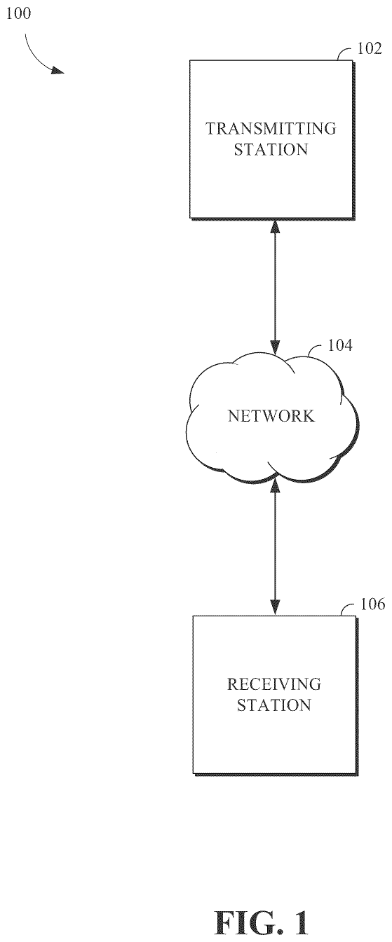

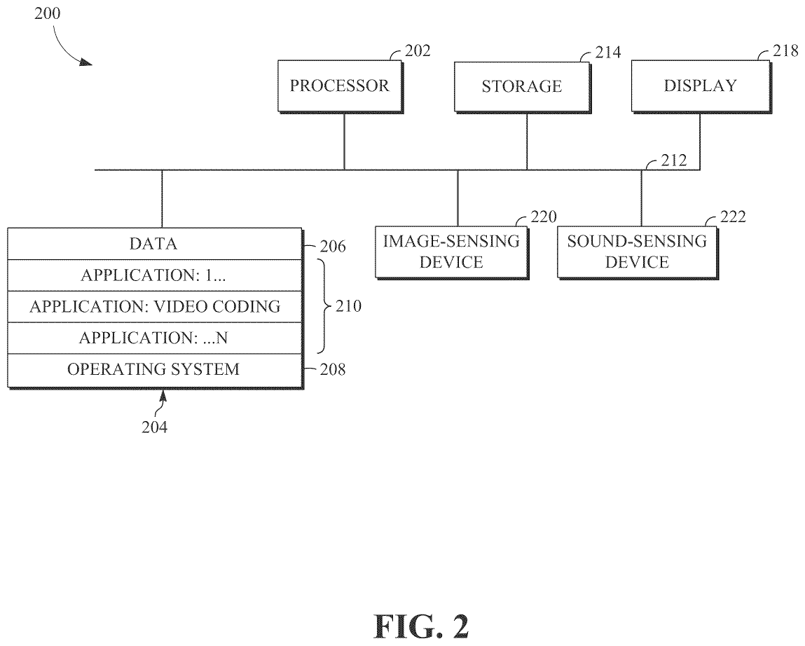

Further details of template matching using available peripheral pixels are described herein with initial reference to a system in which it can be implemented. FIG. 1 is a schematic of a video encoding and decoding system 100. A transmitting station 102 can be, for example, a computer having an internal configuration of hardware such as that described in FIG. 2. However, other suitable implementations of the transmitting station 102 are possible. For example, the processing of the transmitting station 102 can be distributed among multiple devices.

A network 104 can connect the transmitting station 102 and a receiving station 106 for encoding and decoding of the video stream. Specifically, the video stream can be encoded in the transmitting station 102 and the encoded video stream can be decoded in the receiving station 106. The network 104 can be, for example, the Internet. The network 104 can also be a local area network (LAN), wide area network (WAN), virtual private network (VPN), cellular telephone network or any other means of transferring the video stream from the transmitting station 102 to, in this example, the receiving station 106.

The receiving station 106, in one example, can be a computer having an internal configuration of hardware such as that described in FIG. 2. However, other suitable implementations of the receiving station 106 are possible. For example, the processing of the receiving station 106 can be distributed among multiple devices.

Other implementations of the video encoding and decoding system 100 are possible. For example, an implementation can omit the network 104. In another implementation, a video stream can be encoded and then stored for transmission at a later time to the receiving station 106 or any other device having memory. In one implementation, the receiving station 106 receives (e.g., via the network 104, a computer bus, and/or some communication pathway) the encoded video stream and stores the video stream for later decoding. In an example implementation, a real-time transport protocol (RTP) is used for transmission of the encoded video over the network 104. In another implementation, a transport protocol other than RTP may be used, e.g., a Hypertext Transfer Protocol (HTTP) video streaming protocol.

When used in a video conferencing system, for example, the transmitting station 102 and/or the receiving station 106 may include the ability to both encode and decode a video stream as described below. For example, the receiving station 106 could be a video conference participant who receives an encoded video bitstream from a video conference server (e.g., the transmitting station 102) to decode and view and further encodes and transmits its own video bitstream to the video conference server for decoding and viewing by other participants.

FIG. 2 is a block diagram of an example of a computing device 200 (e.g., an apparatus) that can implement a transmitting station or a receiving station. For example, the computing device 200 can implement one or both of the transmitting station 102 and the receiving station 106 of FIG. 1. The computing device 200 can be in the form of a computing system including multiple computing devices, or in the form of one computing device, for example, a mobile phone, a tablet computer, a laptop computer, a notebook computer, a desktop computer, and the like.

A CPU 202 in the computing device 200 can be a conventional central processing unit. Alternatively, the CPU 202 can be any other type of device, or multiple devices, capable of manipulating or processing information now existing or hereafter developed. Although the disclosed implementations can be practiced with one processor as shown, e.g., the CPU 202, advantages in speed and efficiency can be achieved using more than one processor.

A memory 204 in computing device 200 can be a read only memory (ROM) device or a random-access memory (RAM) device in an implementation. Any other suitable type of storage device can be used as the memory 204. The memory 204 can include code and data 206 that is accessed by the CPU 202 using a bus 212. The memory 204 can further include an operating system 208 and application programs 210, the application programs 210 including at least one program that permits the CPU 202 to perform the methods described here. For example, the application programs 210 can include applications 1 through N, which further include a video coding application that performs the methods described here. Computing device 200 can also include a secondary storage 214, which can, for example, be a memory card used with a mobile computing device. Because the video communication sessions may contain a significant amount of information, they can be stored in whole or in part in the secondary storage 214 and loaded into the memory 204 as needed for processing.

The computing device 200 can also include one or more output devices, such as a display 218. The display 218 may be, in one example, a touch sensitive display that combines a display with a touch sensitive element that is operable to sense touch inputs. The display 218 can be coupled to the CPU 202 via the bus 212. Other output devices that permit a user to program or otherwise use the computing device 200 can be provided in addition to or as an alternative to the display 218. When the output device is or includes a display, the display can be implemented in various ways, including by a liquid crystal display (LCD), a cathode-ray tube (CRT) display or light emitting diode (LED) display, such as an organic LED (OLED) display.

The computing device 200 can also include or be in communication with an image-sensing device 220, for example a camera, or any other image-sensing device 220 now existing or hereafter developed that can sense an image such as the image of a user operating the computing device 200. The image-sensing device 220 can be positioned such that it is directed toward the user operating the computing device 200. In an example, the position and optical axis of the image-sensing device 220 can be configured such that the field of vision includes an area that is directly adjacent to the display 218 and from which the display 218 is visible.

The computing device 200 can also include or be in communication with a sound-sensing device 222, for example a microphone, or any other sound-sensing device now existing or hereafter developed that can sense sounds near the computing device 200. The sound-sensing device 222 can be positioned such that it is directed toward the user operating the computing device 200 and can be configured to receive sounds, for example, speech or other utterances, made by the user while the user operates the computing device 200.

Although FIG. 2 depicts the CPU 202 and the memory 204 of the computing device 200 as being integrated into one unit, other configurations can be utilized. The operations of the CPU 202 can be distributed across multiple machines (wherein individual machines can have one or more of processors) that can be coupled directly or across a local area or other network. The memory 204 can be distributed across multiple machines such as a network-based memory or memory in multiple machines performing the operations of the computing device 200. Although depicted here as one bus, the bus 212 of the computing device 200 can be composed of multiple buses. Further, the secondary storage 214 can be directly coupled to the other components of the computing device 200 or can be accessed via a network and can comprise an integrated unit such as a memory card or multiple units such as multiple memory cards. The computing device 200 can thus be implemented in a wide variety of configurations.

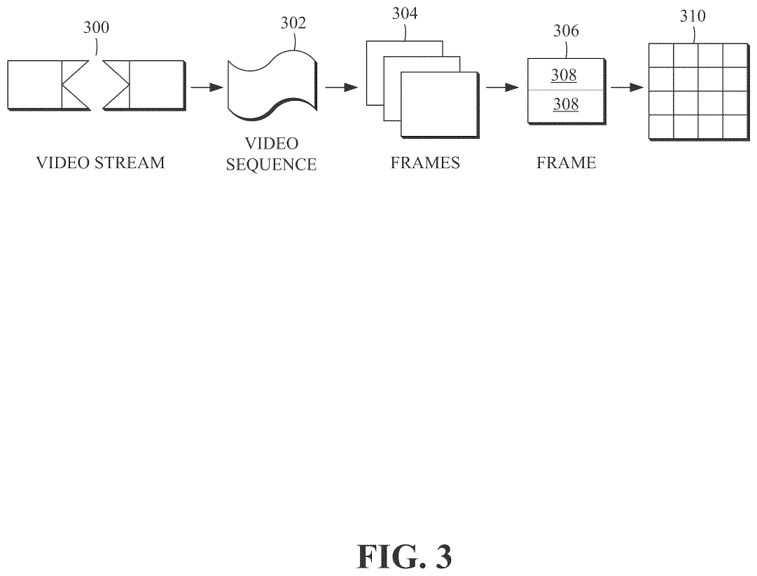

FIG. 3 is a diagram of an example of a video stream 300 to be encoded and subsequently decoded. The video stream 300 includes a video sequence 302. At the next level, the video sequence 302 includes a number of adjacent frames 304. While three frames are depicted as the adjacent frames 304, the video sequence 302 can include any number of adjacent frames 304. The adjacent frames 304 can then be further subdivided into individual frames, e.g., a frame 306. At the next level, the frame 306 can be divided into a series of planes or segments 308. The segments 308 can be subsets of frames that permit parallel processing, for example. The segments 308 can also be subsets of frames that can separate the video data into separate colors. For example, a frame 306 of color video data can include a luminance plane and two chrominance planes. The segments 308 may be sampled at different resolutions.

Whether or not the frame 306 is divided into segments 308, the frame 306 may be further subdivided into blocks 310, which can contain data corresponding to, for example, 16×16 pixels in the frame 306. The blocks 310 can also be arranged to include data from one or more segments 308 of pixel data. The blocks 310 can also be of any other suitable size such as 4×4 pixels, 8×8 pixels, 16×8 pixels, 8×16 pixels, 16×16 pixels, or larger. Unless otherwise noted, the terms block and macro-block are used interchangeably herein.

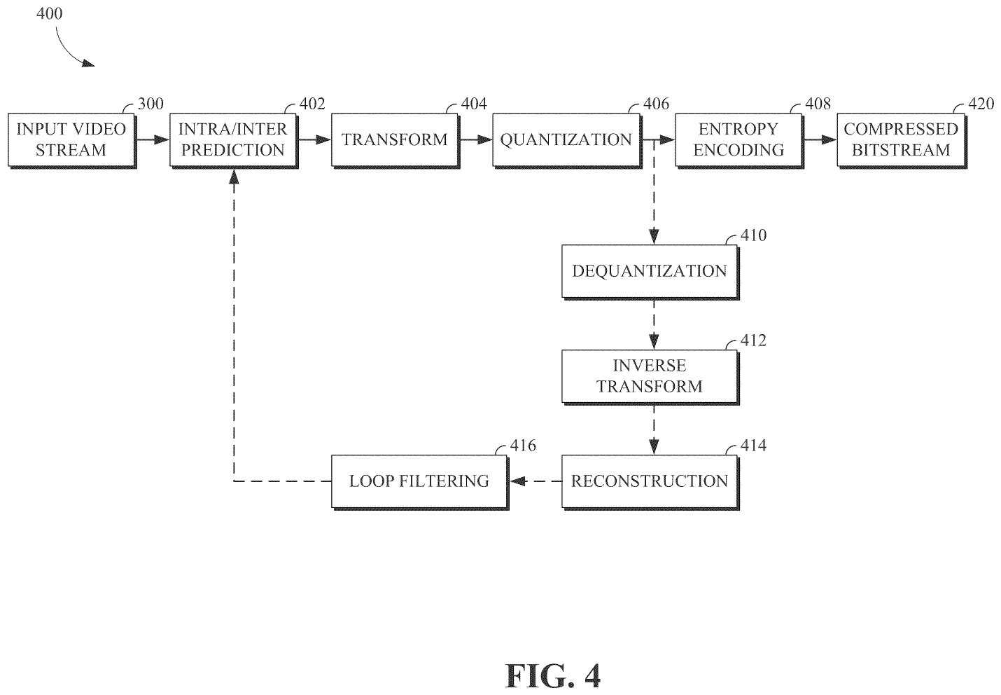

FIG. 4 is a block diagram of an encoder 400. The encoder 400 can be implemented, as described above, in the transmitting station 102 such as by providing a computer software program stored in memory, for example, the memory 204. The computer software program can include machine instructions that, when executed by a processor such as the CPU 202, cause the transmitting station 102 to encode video data in the manner described in FIG. 4. The encoder 400 can also be implemented as specialized hardware included in, for example, the transmitting station 102. In one particularly desirable implementation, the encoder 400 is a hardware encoder.

The encoder 400 has the following stages to perform the various functions in a forward path (shown by the solid connection lines) to produce an encoded or compressed bitstream 420 using the video stream 300 as input: an intra/inter prediction stage 402, a transform stage 404, a quantization stage 406, and an entropy encoding stage 408. The encoder 400 may also include a reconstruction path (shown by the dotted connection lines) to reconstruct a frame for encoding of future blocks. In FIG. 4, the encoder 400 has the following stages to perform the various functions in the reconstruction path: a dequantization stage 410, an inverse transform stage 412, a reconstruction stage 414, and a loop filtering stage 416. Other structural variations of the encoder 400 can be used to encode the video stream 300.

When the video stream 300 is presented for encoding, respective frames 304, such as the frame 306, can be processed in units of blocks. At the intra/inter prediction stage 402, respective blocks can be encoded using intra-frame prediction (also called intra-prediction) or inter-frame prediction (also called inter-prediction). In any case, a prediction block can be formed. In the case of intra-prediction, a prediction block may be formed from samples in the current frame that have been previously encoded and reconstructed. In the case of inter-prediction, a prediction block may be formed from samples in one or more previously constructed reference frames.

Next, still referring to FIG. 4, the prediction block can be subtracted from the current block at the intra/inter prediction stage 402 to produce a residual block (also called a residual). The transform stage 404 transforms the residual into transform coefficients in, for example, the frequency domain using block-based transforms. The quantization stage 406 converts the transform coefficients into discrete quantum values, which are referred to as quantized transform coefficients, using a quantizer value or a quantization level. For example, the transform coefficients may be divided by the quantizer value and truncated. The quantized transform coefficients are then entropy encoded by the entropy encoding stage 408. The entropy-encoded coefficients, together with other information used to decode the block, which may include for example the type of prediction used, transform type, MVs and quantizer value, are then output to the compressed bitstream 420. The compressed bitstream 420 can be formatted using various techniques, such as variable length coding (VLC) or arithmetic coding. The compressed bitstream 420 can also be referred to as an encoded video stream or encoded video bitstream, and the terms will be used interchangeably herein.

The reconstruction path in FIG. 4 (shown by the dotted connection lines) can be used to ensure that the encoder 400 and a decoder 500 (described below) use the same reference frames to decode the compressed bitstream 420. The reconstruction path performs functions that are similar to functions that take place during the decoding process that are discussed in more detail below, including dequantizing the quantized transform coefficients at the dequantization stage 410 and inverse transforming the dequantized transform coefficients at the inverse transform stage 412 to produce a derivative residual block (also called a derivative residual). At the reconstruction stage 414, the prediction block that was predicted at the intra/inter prediction stage 402 can be added to the derivative residual to create a reconstructed block. The loop filtering stage 416 can be applied to the reconstructed block to reduce distortion such as blocking artifacts.

Other variations of the encoder 400 can be used to encode the compressed bitstream 420. For example, a non-transform-based encoder can quantize the residual signal directly without the transform stage 404 for certain blocks or frames. In another implementation, an encoder can have the quantization stage 406 and the dequantization stage 410 combined in a common stage.

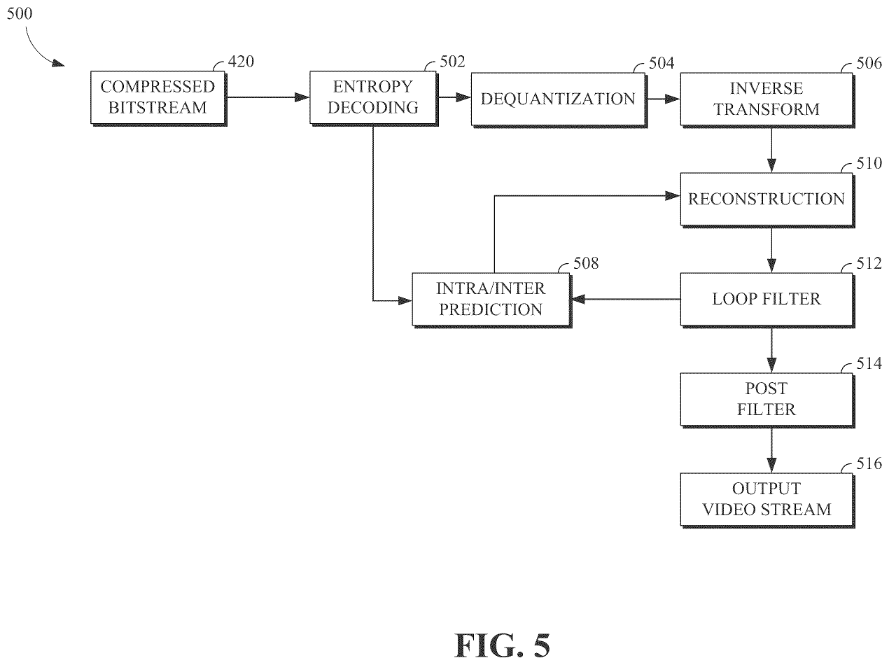

FIG. 5 is a block diagram of a decoder 500. The decoder 500 can be implemented in the receiving station 106, for example, by providing a computer software program stored in the memory 204. The computer software program can include machine instructions that, when executed by a processor such as the CPU 202, cause the receiving station 106 to decode video data in the manner described in FIG. 5. The decoder 500 can also be implemented in hardware included in, for example, the transmitting station 102 or the receiving station 106.

The decoder 500, similar to the reconstruction path of the encoder 400 discussed above, includes in one example the following stages to perform various functions to produce an output video stream 516 from the compressed bitstream 420: an entropy decoding stage 502, a dequantization stage 504, an inverse transform stage 506, an intra/inter prediction stage 508, a reconstruction stage 510, a loop filtering stage 512 and a post-loop filtering stage 514. Other structural variations of the decoder 500 can be used to decode the compressed bitstream 420.

When the compressed bitstream 420 is presented for decoding, the data elements within the compressed bitstream 420 can be decoded by the entropy decoding stage 502 to produce a set of quantized transform coefficients. The dequantization stage 504 dequantizes the quantized transform coefficients (e.g., by multiplying the quantized transform coefficients by the quantizer value), and the inverse transform stage 506 inverse transforms the dequantized transform coefficients to produce a derivative residual that can be identical to that created by the inverse transform stage 412 in the encoder 400. Using header information decoded from the compressed bitstream 420, the decoder 500 can use the intra/inter prediction stage 508 to create the same prediction block as was created in the encoder 400, e.g., at the intra/inter prediction stage 402. At the reconstruction stage 510, the prediction block can be added to the derivative residual to create a reconstructed block. The loop filtering stage 512 can be applied to the reconstructed block to reduce blocking artifacts.

Other filtering can be applied to the reconstructed block. In this example, the post-loop filtering stage 514 is applied to the reconstructed block to reduce blocking distortion, and the result is output as the output video stream 516. The output video stream 516 can also be referred to as a decoded video stream, and the terms will be used interchangeably herein. Other variations of the decoder 500 can be used to decode the compressed bitstream 420. For example, the decoder 500 can produce the output video stream 516 without the post-loop filtering stage 514.

FIG. 6 illustrates an example 600 of subblock-based motion derivation using an affine model. The example 600 is used to illustrate subblock-based motion derivation as implemented by the Versatile Video Coding (VVC) standard. The example 600 includes a four-parameter model 602 and a six-parameter model 604. Instead of the conventional representation of affine model parameters (such as described with respect to equation (1)), FIG. 6 illustrates that the parameters of the affine model are represented by (or derived from) MVs of control point.

In the four-parameter model 602, parameters of the affine model for a coding unit 606 can be defined by a first MV 608 (i.e., MV₀) and a second MV 610 (i.e., MV₁) of a top-left 612 luma sample and a top-right 614 luma sample positions of the coding unit 606. The horizontal component MVₓ and the vertical component MV_{y} of the MV at a coordinate (i, j) of the luma coding block of the coding unit 606 can be calculated using equation (2):

$$\{ \begin{matrix}M {V}_{x} ( i , j ) = \frac{( M {V}_{1 , x} - M {V}_{0 , x} )}{W} i + \frac{( M {V}_{1 , y} - M {V}_{0 , y} )}{W} j + M {V}_{0 , x} \\ M {V}_{y} ( i , j ) = \frac{( M {V}_{1 , y} - M {V}_{0 , y} )}{W} i + \frac{( M {V}_{1 , x} - M {V}_{0 , x} )}{W} j + M {V}_{0 , y}\end{matrix} \qquad ( 2 )$$

In the six-parameter model 604, parameters of the affine model for a coding unit 606 can be defined by a first MV 618 (i.e., MV₀), a second MV 620 (i.e., MV₁), and a third MV 622 (i.e., MV₂) of a top-left 624 luma sample, a top-right 626 luma sample, and a bottom-left 628 luma sample positions of a coding unit 616. The horizontal component MVₓ and the vertical component MV_{y} of the MV at a coordinate (i, j) of the luma coding block of the coding unit 616 can be calculated using equation (3):

$$\{ \begin{matrix}M {V}_{x} ( i , j ) = \frac{( M {V}_{1 , x} - M {V}_{0 , x} )}{W} i + \frac{( M {V}_{2 , x} - M {V}_{0 , x} )}{H} j + M {V}_{0 , x} \\ M {V}_{y} ( i , j ) = \frac{( M {V}_{1 , y} - M {V}_{0 , y} )}{W} i + \frac{( M {V}_{2 , y} - M {V}_{0 , y} )}{H} j + M {V}_{0 , y}\end{matrix} \qquad ( 3 )$$

In equation (2), W is the width of the coding unit 606; and in equation (3), W and H are the width and height, respectively, of the coding unit 616.

In an example, a compressed bitstream, such as the compressed bitstream 420 of FIG. 5, may include one or more syntax elements indicating whether the four-parameter or the six-parameter model is to be applied and also include the MVs (i.e., the horizontal and the vertical components therefor). That the compressed bitstream includes the MVs can also include that the compressed bitstream includes MV differences, as a person skilled in the art recognized. As such, instead of signaling the MVs of the control points, MV differences may be signaled. When signaling the affine motion for MV differences, the MV differences between the actual control point MVs and MV predictors therefor are signaled.

To simplify the affine prediction (i.e., to reduce the computational complexity), affine prediction may be applied at the sub-block level. A coding unit can be divided into sub-blocks. Each of the sub-blocks can be of size M×N (i.e., 4×4) luma samples. Each of the sub-blocks can be predicted with a translational model according to a respective translational motion model that is calculated for the sub-block using the affine parameters (either equation (2) or equation (3), as the case may be).

To illustrate, a coding unit 630 may be the coding unit 606, which is to be predicted using the four-parameter model 602. The coding unit 606 is divided into sub-blocks, which include sub-blocks 632 and 634. To derive the translational MV of each M×N luma subblock, a MV (e.g., an MV 638) of a center sample (e.g., a pixel at a location 636) of each subblock (e.g., the sub-block 632) can be calculated according to above equations (in this case, equation (2)). The calculated MV can be rounded to predefined fractional accuracy (e.g., 1/16 fraction accuracy). Motion compensation interpolation filters can be applied to generate a prediction of each sub-block using the derived MV of the sub-block. The subblock size of chroma-components can also set to be M×N (e.g., 4×4). The MV of an M×N chroma subblock can be calculated as the average of the MVs of the top-left and bottom-right luma sub-blocks in the collocated 2M×2N luma region.

A problem with the four-parameter and six-parameter affine models of VCC is the high signaling cost.

In some implementations, the sub-block size can be 1×1 therewith resulting in pixel-level affine prediction. Pixel-level affine prediction is more accurate than the subblock-based motion derivation using an affine model described above. However, pixel-level interpolations required for pixel-level affine prediction can be computationally expensive and may be impractical. Furthermore, the memory bandwidth requirement for hardware implementations can also be impractically high.

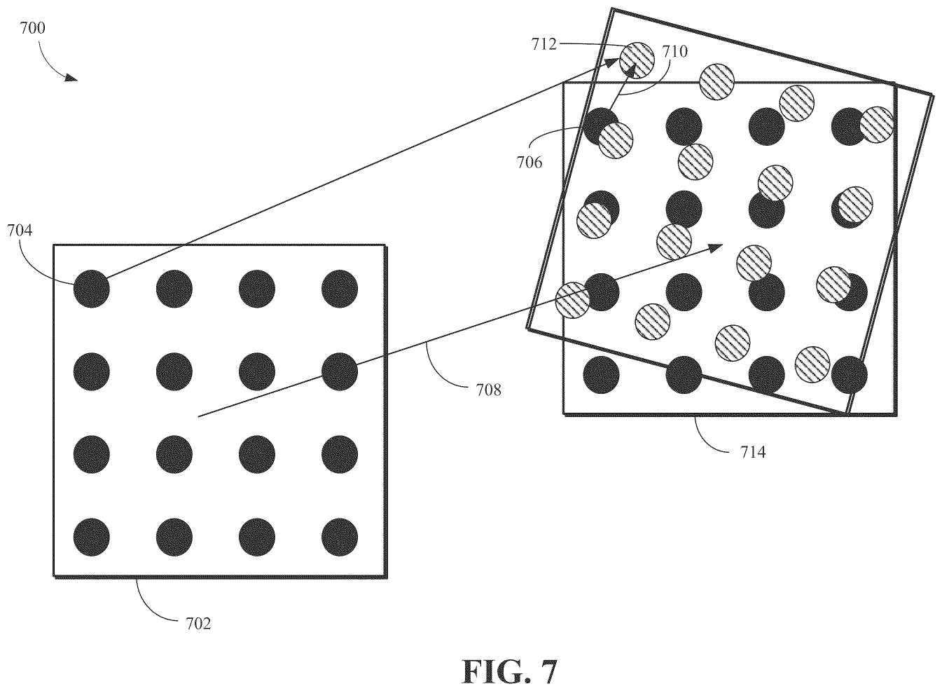

FIG. 7 illustrates an example 700 of prediction refinement with optical flow (PROF). PROF is an inter-prediction technique that is also used in VVC.

Subblock-based motion derivation using an affine model, as described with respect to FIG. 6, can have the benefits of saved memory access bandwidth and reduced computation complexity compared to, for example, pixel based (i.e., pixel by pixel) motion compensation using an affine model. However, these benefits come at the cost of prediction accuracy.

To achieve a finer granularity of motion compensation, PROF can be used to refine a sub-block based affine motion compensated prediction without increasing the memory access bandwidth for motion compensation. PROF can be used to compensate for the prediction error of subblock-based motion derivation using an affine model described with respect to FIG. 6 by applying an optical flow-based sample-wise refinement to the prediction. After a sub-block based affine motion compensation is performed, luma prediction can be refined by adding a difference derived by an optical flow equation (described below).

A sub-block 702 can be one of the sub-blocks of a coding unit. For example, the sub-block 702 can be one of the sub-blocks 632 or 634 of FIG. 6. P(i, j) denotes the prediction at position (i, j) in the sub-block 702 and is predicted from sample I(x, y) at position (x, y) in a reference picture using the sub-block MV (i.e., the MV of the center pixel of the sub-block), which is calculated as described with respect to equation (2) or equation (3), as the case may be. To illustrate, A pixel 704 (e.g., P(0, 0)) is predicted from pixel 706 (e.g., I(0,0)) using an MV 708 (i.e., the MV of the sub-block 702). If (u_{i,j}, v_{i,j}) is a displacement (e.g., a displacement 710) between the MV of the sample at (i, j) and the subblock MV, then I(x+u_{i,j}, y+v_{i,j})=I′(i, j) (e.g., a prediction 712) would be the prediction if the MV of the sample P(i, j) were to be used for motion compensation. PROF calculates the values I′(i, j). For a given sub-block, PROF can be described using the following four steps.

In a first step, subblock-based affine motion compensation, as described with respect to FIG. 6, is performed to generate a subblock prediction I(i, j) for the sub-block. That is, for the sub-block 702, a prediction block 714 is generated.

In a second step, spatial gradients Gₓ(i, j) and G_{y}(i, j) of the sub-block prediction are computed at each sample location (i, j) in the sub-block using a 3-tap filter [−1, 0, 1] according to equation (4), where shift1 (e.g., shift1=6) is an empirically derived constant that is used to control the precision of the gradient. The sub-block prediction is extended by one sample on each side for the gradient calculation by copying from the nearest integer positions in the reference picture.

$$\{ \begin{matrix}{G}_{x} ( i , j ) = ( I ( i + 1 , j ) ≫ shift 1 ) - ( I ( i - 1 , j ) ≫ shift 1 ) \\ {G}_{y} ( i , j ) = ( I ( i , j + 1 ) ≫ shift 1 ) - ( I ( i , j - 1 ) ≫ shift 1 )\end{matrix} \qquad ( 4 )$$

In a third step, the luma prediction refinement can be calculated by the optical flow equation of equation (5) where ΔVₓ(i, j) and ΔV_{y}(i, j) denote differences between sample MV computed by affine model for sample location (i, j), denoted by V(i, j), and the subblock MV of the subblock to which sample (i, j) belongs, as shown in the figure below. ΔVₓ(i, j) and ΔV_{y}(i, j) are quantized in the unit of 1/32 luma sample precision.

$$Δ I ( i , j ) = {G}_{x} ( i , j ) \cdot Δ {V}_{x} ( i , j ) + {G}_{y} ( i , j ) \cdot Δ {V}_{y} ( i , j ) \qquad ( 5 )$$

Since the affine model parameters and the sample location relative to the sub-block center are not changed from subblock to subblock, ΔV(i, j) can be calculated for the first subblock, and reused for the other subblocks in the same coding unit. Let u_{i,j} and v_{i,j} be the horizontal and vertical offsets from the sample location (i, j) to the center of the sub-block (x_{SB}, Y_{SB}), then ΔV(i, j) can be derived using equation (6):

$$\{ \begin{matrix}{u}_{i , j} = i - {x}_{SB} \\ {v}_{i , j} = j - {y}_{SB} \\ Δ {V}_{x} ( i , j ) = a \cdot {u}_{i , j} + b \cdot {v}_{i , j} \\ Δ {V}_{y} ( i , j ) = d \cdot {u}_{i , j} + e \cdot {v}_{i , j}\end{matrix} \qquad ( 6 )$$

In equation (6), the center of the subblock (x_{SB}, Y_{SB}) can be calculated as ((W_{SB}−1)/2, ((H_{SB}−1)/2), where W_{SB} and H_{SB} are the subblock width and height, respectively.

The parameters a, b, d, and e of equation (6) can be calculated using equation (7) or equation (8) in the case of a four-parameter affine model or a six-parameter affine model, respectively.

$$\{ \begin{matrix}a = e = \frac{{v}_{1 x} - {v}_{0 x}}{w} \\ d = - b = \frac{{v}_{1 y} - {v}_{0 y}}{w}\end{matrix} \qquad ( 7 )$$

$$\{ \begin{matrix}a = \frac{{v}_{1 x} - {v}_{0 x}}{w} \\ b = \frac{{v}_{2 x} - {v}_{0 x}}{h} \\ d = \frac{{v}_{1 y} - {v}_{0 y}}{w} \\ e = \frac{{v}_{2 y} - {v}_{0 y}}{h}\end{matrix} \qquad ( 8 )$$

In a fourth step, the luma prediction refinement ΔI(i, j) is added to the sub-block prediction I(i, j). The final prediction I′(i, j) is generated using equation (9):

$$I ( x + {u}_{i , j} , y + {v}_{i , j} ) = {I}^{′} ( i , j ) = Δ I ( i , j ) + I ( i , j ) \qquad ( 9 )$$

PROF is not applied in a case that the MVs of the control points are the same, which indicates that the coding unit only has translational motion. PROF is also not applied in a case that the affine motion parameters are greater than a specified limit.

While this two-step affine prediction (i.e., 4×4 level affine prediction+PROF) in VVC provides good coding efficiency, it is associated with high computational complexity.

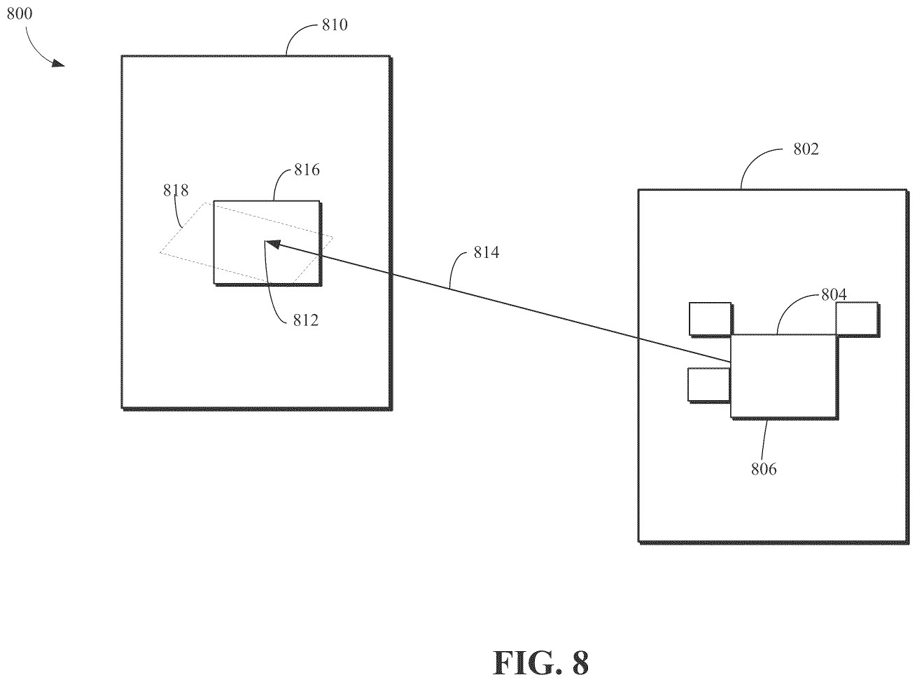

FIG. 8 illustrates another example 800 of affine motion compensation. The example 800 is used to describe affine motion derivation as implemented by the Alliance for Open Media Video 1 (AV1) standard.

The affine model is applied at sub-blocks of size 8×8. A prediction block of a current frame (e.g., a current frame 802) is decomposed into 8×8 units (such as a sub-block 804). A center pixel (x₀, y₀) (e.g., a center pixel 806) is projected into a reference frame 810 to obtain a reference center pixel (x₁, y₁) (e.g., a reference center pixel 812) using translational motion (e.g., using an MV 814). The projection operation identifies a reference block 816 in the reference frame 810. The pixels at positions (x, y) of the reference block 816 are scaled and rotated around the reference center pixel (x₁, y₁) to form an affine projection (x′, y′) resulting in an affine prediction block 818.

The parameters of the translational motion can be transmitted in a compressed bitstream from an encoder to a decoder. The other parameters of the affine model are locally derived by the decoder using reconstructed blocks. The decoder selects reconstructed neighboring blocks of a current block and whose MVs points toward the same reference frame as the current block. For each selected reference block, its center point is offset by the center location of the current block to create an original sample position. An MV difference between the two blocks is added to the offset version to form a destination sample position after the affine transformation. A least square regression is conducted over the available original and destination sample position pairs to calculate the remaining affine model parameters.

In AV1, affine prediction is reformulated as a multiplication of two shearing matrices, as shown in equation (10), where a, b, d, e are the affine model parameters described above with respect to equations (7) and (8), and the parameters α, β, γ, δ are the shearing parameters, which can be calculated as shown in equations (11).

$$[ \begin{matrix}1 + a & b \\ d & 1 + e\end{matrix} ] = [ \begin{matrix}1 & 0 \\ γ & 1 + δ\end{matrix} ] [ \begin{matrix}1 + α & β \\ 0 & 1\end{matrix} ] \qquad ( 10 )$$

$$\{ \begin{matrix}α = a \\ β = b \\ γ = d / ( 1 + a ) \\ δ = e - b \cdot d / ( 1 + a )\end{matrix} \qquad ( 11 )$$

The affine prediction (e.g., the affine prediction block 818) can be achieved (e.g., obtained) by combining interpolation and a two-step shearing process: A second shear is applied by a horizontal filter, while the first shear is applied by a vertical filter. For each shear, interpolation is conducted with an 8-tap sub-pel filter. An advantage of this approach is that it allows for the application of a separable filter to the entire block, rather than at a per-pixel. The overall affine prediction process can be re-summarized using the following steps.

In a first step, an input block is split into 8×8 blocks. For each sub-block (e.g., the sub-block 804), a central point (4, 4) (e.g., the center pixel 806) is projected to get an overall position of a reference block (e.g., the reference block 816). In a second step (i.e., a horizontal filtering step), 15 rows of 8 pixels each are generated by filtering horizontally with an 8-tap filter, where each pixel gets a different horizontal offset in 1/64th-pel precision. In a third step (i.e., a vertical filtering step), the output 8×8 block (e.g., the affine prediction block 818) is generated by filtering vertically using an 8-tap filter, where each pixel gets a different vertical offset in 1/64th-pel precision.

Constraints are imposed on the affine motion compensation in AV1 to simplify the implementation. A constrained region of pixels fetched from a reference frame to a 15×15 area is used. The constraint in turn requires that the parameters of the affine model must satisfy the following conditions:

$$4 \cdot \vert α \vert + 7 \cdot \vert β \vert \leq 1 and 4 \cdot \vert γ \vert + 4 \cdot \vert δ \vert \leq 1$$

However, such conditions may not be met in cases of medium and fast affine motion therewith resulting in suboptimal prediction efficiency.

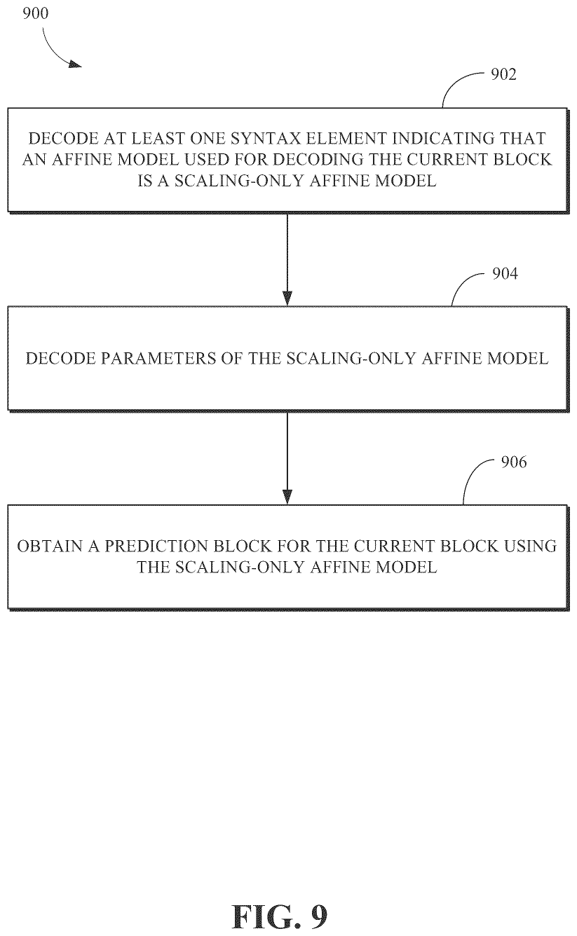

FIG. 9 is a flowchart diagram of a method or technique 900 for decoding a current block using an affine model. The technique 900 can be implemented, for example, as a software program that may be executed by computing devices such as transmitting station 102 or receiving station 106. The software program can include machine-readable instructions that may be stored in a memory such as the memory 204 or the secondary storage 214, and that, when executed by a processor, such as CPU 202, may cause the computing device to perform the technique 900. The technique 900 may be implemented in whole or in part in the intra/inter prediction stage 508 of the decoder 500 of FIG. 5. The technique 900 can be implemented using specialized hardware or firmware. Multiple processors, memories, or both, may be used.

At block 902, at least one syntax element indicating that an affine model used for decoding the current block is a scaling-only affine model is decoded from a compressed bitstream, such as the bitstream 420 of FIG. 5. The at least one syntax element is not itself a parameter of the affine model; rather the at least one syntax element is indicative of a prediction mode of the current block. That is, the at least one syntax element indicates that a scaling-only affine mode is signaled in the compressed bitstream.

The at least one syntax element can indicate a three-parameter scaling-only affine model or a four-parameter scaling-only affine model. The scaling-only affine model can be characterized or described by parameters a, b, d, and e of one of equations (7) or (8).

The three-parameter scaling-only affine model indicates that the same scaling factor is used in the horizontal and vertical directions, where a=e and b=d=0 and the scaling-only affine model consists of three parameters (i.e., a, d, and e). The at least one syntax element indicates that the scaling-only affine model results in applying a same scaling factor in a horizontal direction and a vertical direction.

The four-parameter scaling-only affine model indicates that different scaling factors are used in the for horizontal and vertical directions, where a≠e and b=d=0. As such, the at least one syntax element indicates that the scaling-only affine model results in applying a first scaling factor in a horizontal and a second scaling factor in a vertical direction. The scaling-only affine model, in this case, consists of four parameters (i.e., a, b, d, and e).

In an example, the scaling-only affine modes may be signaled on top of (e.g., in addition to, subsequent to, etc.) the four-parameter or the six-parameter affine model type described above with respect to FIG. 6. After the four-parameter or the six-parameter affine model type is signaled, a scaling-only flag can be further signaled to indicate whether the scaling-only affine model is used. As such, the at least one syntax element includes a first syntax element that indicates that the current block is to be predicted using an affine model and a second syntax element that is a flag indicating that the affine model is the scaling-only affine model. That is, the first syntax element indicates one of the four-parameter or the six-parameter affine model type.

If the affine model type is the four-parameter model type, and the scaling-only flag is true, then the three-parameter scaling-only affine model is used. On the other hand, if the affine model type is the six-parameter model type, and the scaling-only flag is true, then the four-parameter scaling-only affine model is used. Said another way, the first syntax element may indicate that the affine model is the four-parameter affine model and the flag can indicate that the three parameters of the scaling-only affine model can be obtained from the compressed bitstream; or the first syntax element may indicate that the affine model is the six-parameter affine model and the flag can indicate that the four parameters of the scaling-only affine model can be obtained from the compressed bitstream.

In another example, the compressed bitstream can include an affine mode that is or indicates one of three affine model types is to be used: a scaling-only affine model type, the four-parameter affine model type described with respect to FIG. 6, and the six-parameter affine model type also described above with respect to FIG. 6. When the scaling-only affine model type signaled, another flag may be further signaled to indicate whether the three-parameter scaling-only or the four-parameter scaling only affine model is used. As such, the at least one syntax element can include a first syntax element that indicates an affine mode that is selected from a set of affine modes that include a scaling-only mode, a four-parameter affine mode, and a six-parameter affine mode. In a case that the first syntax element is the scaling-only mode, the at least one syntax element also includes a second syntax element that indicates whether the scaling-only affine model to be used is the three-parameter scaling only model or the four-parameter scaling-only model.

In an example, the flag can be entropy decoded using a probability distribution that is selected based on a context that includes a first scaling-only flag of an above neighboring block of the current block and a second scaling-only flag of a left neighboring block of the current block.

At 904, parameters of the scaling-only affine model are decoded. Decoding the parameters of the scaling-only affine model can mean or include decoding other values that can be used to obtain (e.g., calculate) the parameters of the scaling-only affine model. As described above, the other values can be components of MVs of control points. In an example, decoding MV components can mean or include decoding MV differences, which are then added to predictors of the MVs to obtain the MV components themselves.

In example, when the three-parameter scaling-only affine mode is used, in addition to the MV components (v₀ₓ, v_{0y}) (or differences therefor) of a first control point (e.g., the top-left 612 of FIG. 6), the horizontal component v₁ₓ (or a difference therefor) of the MV of a second control point (e.g., the top-right 614 of FIG. 6) can be signaled. The vertical component v_{1y} of the MV of the second control point is not signaled and can be set to the vertical component v_{0y} of the MV of the first control point. Then the vertical component v₂ₓ of a third control point can be set to v₀ₓ and the vertical component v_{2y} of the third control point can be derived as {(v}₁ₓ−v₀ₓ)·H/W+v_{0y}. Alternatively, the vertical component v_{2y} (or a difference therefor) of the MV of the third control point may be signaled and the horizontal component v₁ₓ of the MV of the second control point can derived from the vertical component v_{2y}. During the derivation, rounding towards one of positive infinity, negative infinity, or zero may be used.

As such, in an example, decoding, from the compressed bitstream, the parameters of the scaling-only affine model can include decoding, from the compressed bitstream, a horizontal component v₀ₓ and a vertical component v_{0y} of a motion vector (MV) of a first control point, and a horizontal component v₁ₓ of an MV of a second control point; setting a vertical component v_{1y} of the MV of the second control point to the vertical component v_{0y} of the MV of the first control point; setting a horizontal component v₂ₓ of an MV of a third control point to the horizontal component v₀ₓ of the MV of the first control point; and setting a vertical component v_{2y} of the MV of the third control point based on the horizontal component of the MV of the first control point, the horizontal component of the MV of the second control point, and the vertical component of the MV of the first control point.

In an example, the signaling of v₁ₓ or v_{2y} may depend on the width (W) and the height (H) of the current block. If the height is not smaller than the width, then v_{2y} (or a difference therefor) is signaled; otherwise, the v₁ₓ (or a difference therefor) is signaled. As such, decoding, from the compressed bitstream, the parameters of the scaling-only affine model can include decoding, from the compressed bitstream, a horizontal component v₀ₓ and a vertical component v_{0y} of an MV of a first control point; and determining based on a width and a height of the current block whether to decode a horizontal component v₁ₓ of an MV of a second control point or to decode a vertical component v_{2y} of an MV of a third control point. In response to determining that the height is not smaller than the width, then the vertical component v_{2y} of the MV of the third control point can be decoded; and in response to determining that the height is smaller than the width, then the horizontal component v₁ₓ of the MV of the second control point can be decoded.

In an example, when the four-parameter scaling only affine is used, in addition to the components (v₀ₓ, v_{0y}) of the MV of the first control point, the horizontal component v₁ₓ of an MV of a second control point and the vertical component v_{2y} of the MV of a third control point are signaled in the compressed bitstream while the vertical component v_{1y} of the MV of the second control point and the horizontal component v₂ₓ of the MV of the third control point can be set to v_{0y} and v₀ₓ, respectively.

At 906, a prediction block is obtained for the current block using the scaling-only affine model.

In an example, when using a scaling-only affine mode, the shearing model of equation (10) and described with respect to FIG. 8 can be used. The shearing model can be applied at an 8×8 (or different size) sub-block level; and the PROF mode described with respect to FIG. 7 is not further used after the affine prediction. The reason for not using the PROF mode is that when using the scaling-only affine mode, affine parameters b and d are both 0 so that the parameters β and γ (the shearing parameters in equations (10) and (11)) are also zero, which leads to the same prediction results as that of 1×1 affine prediction. Therefore, PROF need not be used.

In an example, whenever an affine prediction has scaling only parameters (whether or not the current block mode is indicated as the scaling-only affine mode), the two-shear affine prediction of FIG. 8 without PROF can be used to generate the prediction. The current block may be bi-predicted using two reference frames where one prediction from two reference pictures where only one prediction has a scaling-only affine while the other prediction does not. In such a case, the current block cannot be predicted using a scaling-only affine model. In such a case, the two-shear prediction without PROF is only used for that prediction.

In an example, scaling-only affine mode information may be inherited in merge mode in the same way as the inheritance of four-parameter and the six-parameter information, as described in the VVC specification. That is, not only is the motion vector copied from the merge block, the scaling-only flag is also copied from the merge block.

In one example, when a merge candidate is constructed based on spatially or temporally neighboring blocks, the current block may not be marked as scaling-only affine mode since whether the current block satisfies the scaling-only condition may not be determined during the parsing stage. Not marking as scaling only means the scaling only flag of this block should be false. In the constructed affine candidate mode of VVC, affine parameters can be combined to construct a new affine vector. In this case, since information is being copied from several blocks, and the several blocks may have different values for the scaling-only flag, then it may not be possible to determine whether the new constructed affine motion should be scaling-only or not. As such, in the case of a constructed affine candidate, the current block can be marked as not scaling-only affine.

In an example, affine parameters may be further refined at the decoder based on certain rules without signaling. If a block whose scaling-only affine flag is true, the refined affine parameters which are determined not to satisfy the scaling-only affine model can be discarded so that the final affine motion of the current block must be scaling-only affine model if the scaling-only affine flag of the current block is true. Whether the parameters of the derived affine model satisfy a scaling-only affine model can be determined by examining the relationships between the parameters of the derived model.

In an example, when getting affine motion predictors from spatial or temporal neighbors for a current block whose scaling-only affine mode flag is true, the affine motion predictors can be adjusted so that the predictors also satisfy the scaling-only affine mode constraint. That the parameters of a predictor can be adjusted so as to satisfy the constraints of a three-parameter or a four-parameters scaling-only affine model, as the case may be. In an example, for a block for which no MV (or differences therefor) are signaled, the adjustment to ensure affine MV predictors satisfy the scaling-only constraint is not performed.

For simplicity of explanation, the techniques described herein, such as the technique 900 of FIG. 9, is depicted and described as a series of steps or operations. However, the steps or operations in accordance with this disclosure can occur in various orders and/or concurrently. Additionally, other steps or operations not presented and described herein may be used. Furthermore, not all illustrated steps or operations may be required to implement a method in accordance with the disclosed subject matter.

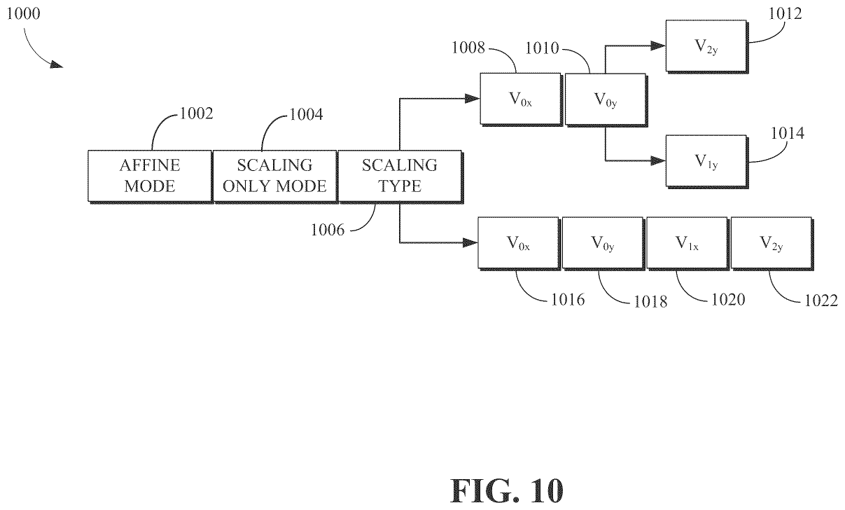

FIG. 10 illustrates an example of a portion of a compressed bitstream 1000 usable with the scaling-only affine mode. The compressed bitstream 1000 includes an affine mode 1002, a scaling-only mode 1004, and a scaling type 1006. The affine mode 1002 indicates that the affine model for a current block is a scaling-only mode, meaning parameters unrelated to scaling (e.g., those related to rotation and shearing) are not included in the bitstream. It is noted that other compressed bitstream structures are possible consistent with the description herein.

The scaling type 1006 indicates whether a three-parameter scaling-only affine model or a four-parameter scaling-only affine model is to be used. Based on the scaling type 1006, the bitstream may include different syntax elements. If the scaling type 1006 indicates a three-parameter scaling-only affine model, the bitstream includes a horizontal component v₀ₓ 1008 and a vertical component v_{0y} 1010 of a motion vector of a first control point. The bitstream then includes either a vertical component v_{2y} 1012 of a motion vector of a third control point, or a horizontal component v₁ₓ 1014 of a motion vector of a second control point, depending on the dimensions of the current block, which the decoder can determine. As described above, if the height of the current block is not smaller than the width, the vertical component v_{2y} 1012 is included; otherwise, the horizontal component v₁ₓ 1014 is included.

If the scaling type 1006 indicates a four-parameter scaling-only affine model, the bitstream includes a horizontal component v₀ₓ 1016 and a vertical component v_{0y} 1018 of a motion vector of a first control point, followed by a horizontal component v₁ₓ 1020 of a motion vector of a second control point, and a vertical component v_{2y} 1022 of a motion vector of a third control point.

In an alternative embodiment, instead of having a dedicated scaling type 1006, the compressed bitstream may include a first syntax element indicating an affine model type (either four-parameter or six-parameter) followed by a scaling-only flag. If the affine model type is a four-parameter affine model and the scaling-only flag is true, then a three-parameter scaling-only affine model is used, with motion vectors as described above for the three-parameter model. If the affine model type is a six-parameter affine model and the scaling-only flag is true, then a four-parameter scaling-only affine model is used, with motion vectors as described above for the four-parameter model.

Some implementations are described below as numbered examples (Example A, B, C, etc.). These examples are provided as examples only and do not limit the other implementations disclosed herein.

Example A is a method for coding a current block that includes decoding, from a compressed bitstream, at least one syntax element indicating that an affine model used for decoding the current block is a scaling-only affine model, where the at least one syntax element is not a parameter of the affine model, and where a prediction for the current block is to be obtained using the affine model; decoding, from the compressed bitstream, parameters of the scaling-only affine model; and obtaining a prediction block for the current block using the scaling-only affine model.

Example B is the method of Example A where the at least one syntax element indicates that a same scaling factor is to be applied in a horizontal direction and a vertical direction.

Example C is the method of Example A where the parameters consist of three parameters.

Example D is the method of Example A where the at least one syntax element indicates that a first scaling factor is to be applied in a horizontal and a second scaling factor is to be applied in a vertical direction.

Example E is the method of Example A where the parameters consist of four parameters.

Example F is the method of Example A where the at least one syntax element include a first syntax element indicating that the current block is to be predicted using the affine model and a second syntax element that is a flag indicating that the affine model is the scaling-only affine model.

Example G is the method of Example F further including entropy decoding the flag using a probability distribution selected based on a context that includes a first scaling-only flag of an above neighboring block of the current block and a second scaling-only flag of a left neighboring block of the current block.

Example H is the method of Example F where the first syntax element indicates that the affine model is a four-parameter affine model and the flag indicates that three parameters are obtained from the compressed bitstream.

Example I is the method of Example F where the first syntax element indicates that the affine model is a six-parameter affine model and the flag indicates that four parameters are obtained from the compressed bitstream.

Example J is a device that includes a memory and a processor. The processor is configured to execute instructions stored in the memory to decode, from a compressed bitstream, at least one syntax element indicating that an affine model used for decoding a current block is a scaling-only affine model, where the at least one syntax element is not a parameter of the affine model, and where a prediction for the current block is to be obtained using the affine model; decode, from the compressed bitstream, parameters of the scaling-only affine model; and obtain a prediction block for the current block using the scaling-only affine model.

Example K is the device of Example J where the at least one syntax element includes a first syntax element, where the first syntax element indicates an affine mode and is selected from a set including a scaling-only mode, a four-parameter affine mode, and a six-parameter affine mode, and where in a case that the first syntax element is the scaling-only mode, the at least one syntax element includes a second syntax element indicating whether the scaling-only affine model is a three-parameter scaling only model or a four-parameter scaling-only model.

Example L is the device of Example J where to decode, from the compressed bitstream, the parameters of the scaling-only affine model includes to: decode, from the compressed bitstream, a horizontal component v₀ₓ and a vertical component v_{0y} of a motion vector (MV) of a first control point, and a horizontal component v₁ₓ of an MV of a second control point; set a vertical component v_{1y} of the MV of the second control point to the vertical component v_{0y} of the MV of the first control point; set a horizontal component v₂ₓ of an MV of a third control point to the horizontal component v₀ₓ of the MV of the first control point; and set a vertical component v_{2y} of the MV of the third control point based on the horizontal component v₀ₓ of the MV of the first control point, the horizontal component of the MV of the second control point, and the vertical component of the MV of the first control point.

Example M is the device of Example J where to decode, from the compressed bitstream, parameters of the scaling-only affine model includes to: decode, from the compressed bitstream, a horizontal component v₀ₓ and a vertical component v_{0y} of a first control point; decode a horizontal component v₁ₓ of a second control point; decode a vertical component v_{2y} of a third control point; set a vertical component v_{1y} of the second control point to first vertical component v_{0y} of the first control point; and set a horizontal component v₂ₓ of the third control point to the horizontal component v₀ₓ of the first control point.

Example N is the device of Example J where to decode, from the compressed bitstream, the parameters of the scaling-only affine model includes to: decode, from the compressed bitstream, a horizontal component v₀ₓ and a vertical component v_{0y} of an MV of a first control point; and determine based on a width and a height of the current block whether to decode a horizontal component v₁ₓ of an MV of a second control point or to decode a vertical component v_{2y} of an MV of a third control point.

Example O is the device of Example N where to determine based on the width and the height of the current block whether to decode the horizontal component v₁ₓ of the second control point or to decode the vertical component v_{2y} of the third control point includes to: in response to determining that the height is not smaller than the width, determine to decode the vertical component v_{2y} of the MV of the third control point; and in response to determining that the height is smaller than the width, determine to decode the horizontal component v₁ₓ of the MV of the second control point.

Example P is the device of Example J where the processor is further configured to execute instructions stored in the memory to: apply a shearing-based affine prediction to the current block in response to determining that the at least one syntax element indicates that the affine model is the scaling-only affine model.

Example Q is the device of Example J where to decode, from the compressed bitstream, the at least one syntax element indicating that the affine model is the scaling-only affine model includes to: decode the at least one syntax element indicating that the current block is merged with another block; and determine that the another block is decoded using the scaling-only affine model.

Example R is a non-transitory computer-readable storage medium, including executable instructions that, when executed by a processor, facilitate performance of operations for coding a current block, the operations including: decoding, from a compressed bitstream, at least one syntax element indicating that an affine model used for decoding the current block is a scaling-only affine model, where the at least one syntax element is not a parameter of the affine model, and where a prediction for the current block is to be obtained using the affine model; decoding, from the compressed bitstream, parameters of the scaling-only affine model; and obtaining a prediction block for the current block using the scaling-only affine model.

Example S is the non-transitory computer-readable storage medium of Example R where decoding, from the compressed bitstream, parameters of the scaling-only affine model includes: decoding, from the compressed bitstream, a horizontal component v₀ₓ and a vertical component v_{0y} of a first control point; decoding a horizontal component v₁ₓ of a second control point; decoding a vertical component v_{2y} of a third control point; setting a vertical component v_{1y} of the second control point to first vertical component v_{0y} of the first control point; and setting a horizontal component v₂ₓ of the third control point to the horizontal component v₀ₓ of the first control point.

Example T is the non-transitory computer-readable storage medium of Example R where decoding, from the compressed bitstream, the parameters of the scaling-only affine model includes: decoding, from the compressed bitstream, a horizontal component v₀ₓ and a vertical component v_{0y} of an MV of a first control point; and determining based on a width and a height of the current block whether to decode a horizontal component v₁ₓ of an MV of a second control point or to decode a vertical component v_{2y} of an MV of a third control point.

The aspects of encoding and decoding described above illustrate some examples of encoding and decoding techniques. However, it is to be understood that encoding and decoding, as those terms are used in the claims, could mean compression, decompression, transformation, or any other processing or change of data.

The word “example” is used herein to mean serving as an example, instance, or illustration. Any aspect or design described herein as “example” is not necessarily to be construed as preferred or advantageous over other aspects or designs. Rather, use of the word “example” is intended to present concepts in a concrete fashion. As used in this application, the term “or” is intended to mean an inclusive “or” rather than an exclusive “or.” That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an implementation” or “one implementation” throughout is not intended to mean the same embodiment or implementation unless described as such.

Implementations of the transmitting station 102 and/or the receiving station 106 (and the algorithms, methods, instructions, etc., stored thereon and/or executed thereby, including by the encoder 400 and the decoder 500) can be realized in hardware, software, or any combination thereof. The hardware can include, for example, computers, intellectual property (IP) cores, application-specific integrated circuits (ASICs), programmable logic arrays, optical processors, programmable logic controllers, microcode, microcontrollers, servers, microprocessors, digital signal processors or any other suitable circuit. In the claims, the term “processor” should be understood as encompassing any of the foregoing hardware, either singly or in combination. The terms “signal” and “data” are used interchangeably. Further, portions of the transmitting station 102 and the receiving station 106 do not necessarily have to be implemented in the same manner.

Further, in one aspect, for example, the transmitting station 102 or the receiving station 106 can be implemented using a general-purpose computer or general-purpose processor with a computer program that, when executed, carries out any of the respective methods, algorithms and/or instructions described herein. In addition, or alternatively, for example, a special purpose computer/processor can be utilized which can contain other hardware for carrying out any of the methods, algorithms, or instructions described herein.

The transmitting station 102 and the receiving station 106 can, for example, be implemented on computers in a video conferencing system. Alternatively, the transmitting station 102 can be implemented on a server and the receiving station 106 can be implemented on a device separate from the server, such as a hand-held communications device. In this instance, the transmitting station 102 can encode content using an encoder 400 into an encoded video signal and transmit the encoded video signal to the communications device. In turn, the communications device can then decode the encoded video signal using a decoder 500. Alternatively, the communications device can decode content stored locally on the communications device, for example, content that was not transmitted by the transmitting station 102. Other suitable transmitting and receiving implementation schemes are available. For example, the receiving station 106 can be a generally stationary personal computer rather than a portable communications device and/or a device including an encoder 400 may also include a decoder 500.

Further, all or a portion of implementations of the present disclosure can take the form of a computer program product accessible from, for example, a computer-usable or computer-readable medium. A computer-usable or computer-readable medium can be any device that can, for example, tangibly contain, store, communicate, or transport the program for use by or in connection with any processor. The medium can be, for example, an electronic, magnetic, optical, electromagnetic, or a semiconductor device. Other suitable mediums are also available.

The above-described embodiments, implementations and aspects have been described in order to allow easy understanding of the present invention and do not limit the present invention. On the contrary, the invention is intended to cover various modifications and equivalent arrangements included within the scope of the appended claims, which scope is to be accorded the broadest interpretation so as to encompass all such modifications and equivalent structure as is permitted under the law.

What is claimed is:

1. A method for coding a current block
decoding, from a compressed bitstream, at least one syntax element indicating that an affine model used for decoding the current block is a scaling-only affine model,
wherein the at least one syntax element is not a parameter of the affine model, and
wherein a prediction for the current block is to be obtained using the affine model;
decoding, from the compressed bitstream, parameters of the scaling-only affine model; and
obtaining a prediction block for the current block using the scaling-only affine model.

2. The method of claim 1, wherein the at least one syntax element indicates that a same scaling factor is to be applied in a horizontal direction and a vertical direction.

3. The method of claim 1, wherein the parameters consist of three parameters.

4. The method of claim 1, wherein the at least one syntax element indicates that a first scaling factor is to be applied in a horizontal and a second scaling factor is to be applied in a vertical direction.

5. The method of claim 1, wherein the parameters consist of four parameters.

6. The method of claim 1, wherein the at least one syntax element comprise a first syntax element indicating that the current block is to be predicted using the affine model and a second syntax element that is a flag indicating that the affine model is the scaling-only affine model.

7. The method of claim 6, further comprising:
entropy decoding the flag using a probability distribution selected based on a context that includes a first scaling-only flag of an above neighboring block of the current block and a second scaling-only flag of a left neighboring block of the current block.

8. The method of claim 6, wherein the first syntax element indicates that the affine model is a four-parameter affine model and the flag indicates that three parameters are obtained from the compressed bitstream.

9. The method of claim 6, wherein the first syntax element indicates that the affine model is a six-parameter affine model and the flag indicates that four parameters are obtained from the compressed bitstream.

10. A device, comprising:
a memory; and
a processor, the processor configured to execute instructions stored in the memory to:
decode, from a compressed bitstream, at least one syntax element indicating that an affine model used for decoding a current block is a scaling-only affine model,
wherein the at least one syntax element is not a parameter of the affine model, and
wherein a prediction for the current block is to be obtained using the affine model;
decode, from the compressed bitstream, parameters of the scaling-only affine model; and
obtain a prediction block for the current block using the scaling-only affine model.

11. The device of claim 10, wherein the at least one syntax element includes a first syntax element,
wherein the first syntax element indicates an affine mode and is selected from a set comprising a scaling-only mode, a four-parameter affine mode, and a six-parameter affine mode, and
wherein in a case that the first syntax element is the scaling-only mode, the at least one syntax element includes a second syntax element indicating whether the scaling-only affine model is a three-parameter scaling only model or a four-parameter scaling-only model.

12. The device of claim 10, wherein to decode, from the compressed bitstream, the parameters of the scaling-only affine model comprises to:
decode, from the compressed bitstream, a horizontal component v₀ₓ and a vertical component v_{0y} of a motion vector (MV) of a first control point, and a horizontal component v₁ₓ of an MV of a second control point;
set a vertical component v_{y} of the MV of the second control point to the vertical component v_{0y} of the MV of the first control point;
set a horizontal component v₂ₓ of an MV of a third control point to the horizontal component v₀ₓ of the MV of the first control point; and
set a vertical component v_{2y} of the MV of the third control point based on the horizontal component v₀ₓ of the MV of the first control point, the horizontal component of the MV of the second control point, and the vertical component of the MV of the first control point.

13. The device of claim 10, wherein to decode, from the compressed bitstream, parameters of the scaling-only affine model comprises to:
decode, from the compressed bitstream, a horizontal component v₀ₓ and a vertical component v_{0y} of a first control point;
decode a horizontal component v₁ₓ of a second control point;
decode a vertical component v_{2y} of a third control point;
set a vertical component v_{1y} of the second control point to first vertical component v_{0y} of the first control point; and
set a horizontal component v₂ₓ of the third control point to the horizontal component v₀ₓ of the first control point.

14. The device of claim 10, wherein to decode, from the compressed bitstream, the parameters of the scaling-only affine model comprises to:
decode, from the compressed bitstream, a horizontal component v₀ₓ and a vertical component v_{0y} of an MV of a first control point; and
determine based on a width and a height of the current block whether to decode a horizontal component v₁ₓ of an MV of a second control point or to decode a vertical component v_{2y} of an MV of a third control point.

15. The device of claim 14, wherein to determine based on the width and the height of the current block whether to decode the horizontal component v₁ₓ of the second control point or to decode the vertical component v_{2y} of the third control point comprises to:
in response to determining that the height is not smaller than the width, determine to decode the vertical component v_{2y} of the MV of the third control point; and
in response to determining that the height is smaller than the width, determine to decode the horizontal component v₁ₓ of the MV of the second control point.

16. The device of claim 10, wherein the processor further configured to execute instructions stored in the memory to:
apply a shearing-based affine prediction to the current block in response to determining that the at least one syntax element indicates that the affine model is the scaling-only affine model.

17. The device of claim 10, wherein to decode, from the compressed bitstream, the at least one syntax element indicating that the affine model is the scaling-only affine model comprises to:
decode the at least one syntax element indicating that the current block is merged with another block; and
determine that the another block is decoded using the scaling-only affine model.

18. A non-transitory computer-readable storage medium, comprising executable instructions that, when executed by a processor, facilitate performance of operations for coding a current block, the operations comprising:
decoding, from a compressed bitstream, at least one syntax element indicating that an affine model used for decoding the current block is a scaling-only affine model,
wherein the at least one syntax element is not a parameter of the affine model, and
wherein a prediction for the current block is to be obtained using the affine model;
decoding, from the compressed bitstream, parameters of the scaling-only affine model; and
obtaining a prediction block for the current block using the scaling-only affine model.

19. The non-transitory computer-readable storage medium of claim 18, wherein decoding, from the compressed bitstream, parameters of the scaling-only affine model comprises:
decoding, from the compressed bitstream, a horizontal component v₀ₓ and a vertical component v_{0y} of a first control point;
decoding a horizontal component v₁ₓ of a second control point;
decoding a vertical component v_{2y} of a third control point;
setting a vertical component v_{1y} of the second control point to first vertical component v_{0y} of the first control point; and
setting a horizontal component v₂ₓ of the third control point to the horizontal component v₀ₓ of the first control point.

20. The non-transitory computer-readable storage medium of claim 18, wherein decoding, from the compressed bitstream, the parameters of the scaling-only affine model comprises:
decoding, from the compressed bitstream, a horizontal component v₀ₓ and a vertical component v_{0y} of an MV of a first control point; and
determining based on a width and a height of the current block whether to decode a horizontal component v₁ₓ of an MV of a second control point or to decode a vertical component v_{2y} of an MV of a third control point.
